(19) United States
(12) Patent Application Publication
(10) Pub. No.: US 2018/0036188 A1
(43) Pub. Date: Feb. 8, 2018

(54) Prostration Bed

(71) Applicant: Juanita N. Stallings, Bronx, NY (US)

(72) Inventor: Juanita N. Stallings, Bronx, NY (US)

(21) Appl. No.: 15/643,445

(22) Filed: Jul. 6, 2017

Related U.S. Application Data
(60) Provisional application No. 62/359,065, filed on Jul. 6, 2016.

(51) Int. Cl. A61G 7/07; A47G 33/00; A47C 16/04; A61G 7/015

(52) U.S. Cl. CPC A61G 7/07; A61G 7/015; A47G 33/008; A47C 16/04; A61H 1/02

(57) ABSTRACT

The Prostration Bed, is a portable bed comprising an essentially rectangular padded mat that contains an open allocated space for one's head and is configured specifically for lying in prostrate comfort, stretched out on a bed with one's face downward in reverence or submission.

This patent application claims priority under 35 USC 119 (e) (1) from U.S. Provisional Patent Application Ser. No. 62/359,065 filed Jul. 6, 2016 of common Juanita Stallings entitled “The Peace of Mind Prostrate Bed”, which is incorporated herein by reference as though the same were set forth in its entirety.

### FIELD OF THE INVENTION

The present invention pertains to the field of beds, and more specifically to the field of therapeutic accessories for beds.

### BACKGROUND OF THE INVENTION

The prior art has put forth several designs for therapeutic accessories for beds. Among these are:

US Patent Publication 2013/0071829 to Oleg Berezhkov describes training complexes and methods for optimization of the psycho physiological condition of a person. The proposed training complex consists of a training apparatus, audio video system, training complex control system and methods for developing skills of relaxation and activation of psycho physiological processes. Three types of training apparatus are employed, a special adjustable armchair, the immersion tank and a hyperbaric or hypobaric pressure chamber.

U.S. Pat. No. 8,157,757 to Sastry K Ganti describes a special bed and apparatus, having a fixed section and a movable section that support a person lying face up. The bed and apparatus enable a user to restrain two regions of their body, one on the fixed section and another on the movable section. The bed and apparatus allow the person to self induce traction force between the restrained regions.

US Patent Publication 2009/0105525 to Sanat Maitreya Kumara describes environment affecting meditation systems and environment affecting meditation tools based on combinations of sacred objects. The meditation tools provide for specific arrangements of such tools environments conducive for user meditation. Such meditation tools and related spiritual teachings are available through ecommerce means and by deployment to other industries.

None of these prior art references describe the present invention.

### SUMMARY OF THE INVENTION

It is an object of the present invention to provide a portable bed that contains an open allocated space for one's head and is configured specifically for an individual to lie in prostrate comfort, stretched out on one's stomach with their face facing downward in reverence or submission.

### BRIEF DESCRIPTION OF THE DRAWINGS

FIG. 1 is a prototypical top down diagonal view of the present invention showing an opening for a person's head and a solid cushioning for a person's body and arms.

FIG. 2 is a prototypical top down view of the present invention showing an opening for a person's head and a solid cushioning for a person's body and arms.

FIG. 3 is a prototypical top down side view of the present invention showing an opening for a person's head and a solid cushioning for a person's body and arms.

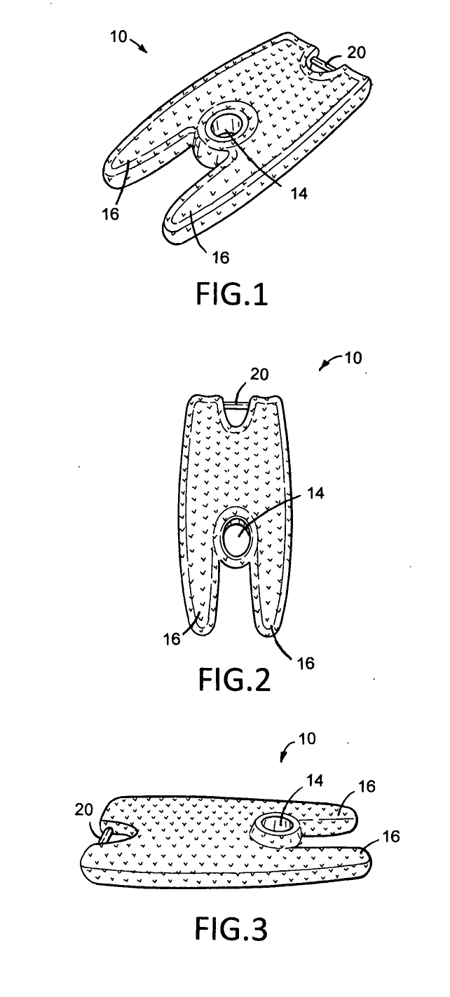

### DETAILED DESCRIPTION OF THE INVENTION

Contemplative practices are activities that guide an individual to direct their attention to a specific focus, often introspectively reflecting or concentrating on a specific sensation or concept. Many spiritual traditions have a long history of using contemplative practices to increase compassion, empathy and attention as well as quiet the mind. Such reflection induces feelings of calm and clear headedness as well as improves concentration and attention. Brain research shows that reflection increases the brain's gray matter density, which reduces sensitivity to pain, enhances an immune system, and helps to regulate difficult emotions and relieve stress. Mindfulness reflection in particular has been proven helpful for people with depression, anxiety, cancer, fibromyalgia, chronic pain, rheumatoid arthritis, type 2 diabetes, chronic fatigue syndrome, and cardiovascular disease.

Prayer is a meditative way of eliciting a relaxation response along with feelings of hope, gratitude and compassion, all of which have a positive effect on overall wellbeing of an individual. The Holy Bible states don't worry about anything, tell God what you need and thank him for all He has done. Then the prayerful person will experience God's peace which exceeds anything understandable. The sixth verse from the fourth book of Phillippians says that His peace will guard your heart and mind as you live in Christ Jesus. A recent study found that clinically depressed adults who believed their prayers were heard by a concerned presence responded much better to treatment than those who did not believe.

Whether rushing to work or helping children with homework while making dinner, most people are living in a chaotic mind space most days. In a rush to accomplish the necessary tasks of living, people sometimes lose any connection with the present moment, thus missing out on what they are doing and how they are feeling. Mindfulness is the practice of purposely focusing one's attention on the present moment and accepting it without judgment. Mindfulness is now being examined scientifically and has been found to be a key element in happiness. Most religions include some type of prayer or reflection technique that helps shift one's thoughts away from their usual preoccupations toward an appreciation of the moment and a larger perspective on life.

The present invention, hereinafter referred to as the Prostration Bed, is a portable bed comprising an essentially rectangular padded mat that contains an open allocated space for one's head and is configured specifically for lying in prostrate comfort, stretched out on a bed with one's face downward in reverence or submission. A user can lie down with arms extended or arms by their side. The Prostration Bed is employable anywhere for use during prayer, reflection and relaxation. The present invention creates a comfortable space for an individual to engage in focused and contemplative reflection and prayer.

The Peace of Mind Prostrate Bed is composed of any suitable material, such as PVC, a polyvinyl chloride, for example, or a urethane plastic rubber material. The Prostration Bed measures approximately thirty nine inches in width and eighty inches in length. Lightweight, and durable, the bed is easily transportable to provide regular practitioners of prayer and reflection with an ability to pray and meditate wherever they may be located. The Peace of Mind Prostrate Bed fold ups for easy storage in a minimal space.

Please refer to the drawings. The Prostration Bed is an essentially rectangular mat. The distal end of the Prostration Bed 10 contains an opening 14 allocated for one's head to reside while in reflection. The opening 14 comfortably nestles one's head and neck area while allowing space for the supine individual to breathe. On each side of the face opening 14 is arm rest 16 for receiving a user's overhead stretched arms. The composition material of the bed allows for regular cleaning by simply wiping the surface with a cleaner or antibacterial agent. The proximal end of the Prostration Bed is equipped with carrying handle 20 for ease in carrying or transporting the prostration bed.

Using the Peace of Mind Prostate Bed is simple and straightforward. A user removes the bed from its storage component, unfolds and extends it lengthwise along a floor or ground surface. The user then kneels and stretches across the bed resting their stomach and hips on the solidly cushioned area and placing their face downward into the round opening 14. The user extends each arm forward passing the sides of their head an ears, and resting each arm on the allotted cushioned arm rest 16 appropriately sized for an extended arm. In this relaxed and supine position, the user may begin a focused period of prayer and meditation. Upon completing these contemplative moments, the user rises from the bed. The user may leave the bed in a specific spot and return to it later. Alternatively, the user may fold the bed, place the bed into its storage component, and return it to a convenient storage area.

The ability to engage in focused mediation using the Prostrate Bed enables a user to take advantage of an opportunity to relieve stress for an upcoming day. Scientific evidence supports the notion that those individuals who meditate become more efficient, less encumbered by distraction and less likely to make mistakes. Practicing regular reflection helps an individual establish more effective and positive avenues of communication between coworkers, family and friends. Using The Peace of Mind Prostrate Bed in one's daily life assists in a narrowing of focus that shuts out the external world while making one's body and mind still. Durably constructed of high quality materials, the present invention will withstand many years of continued use.

In an embodiment, the prostration bed measures approximately thirty nine inches in width and eighty inches in length. Lightweight, and durable, the bed is easily transportable to provide regular practitioners of prayer and reflection with an ability to pray and meditate wherever they may be located. The prostration bed folds up for easy storage in a minimal space.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable bed that contains an open allocated space for one's head and is configured specifically for an individual to lie in prostrate comfort, stretched out on one's stomach with their face facing downward comprising:
an essentially rectangular padded mat comprising an essentially round opening at distal end of the mat capable of receiving a user's head or face, further comprising an arm rest positioned on each side of the head or face opening capable of receiving a user's overhead stretched arms.

2. The portable bed of claim 1 wherein composition material of the bed allows for regular cleaning by simply wiping the surface with a cleaner or antibacterial agent.

3. The portable bed of claim 1 further comprising a carrying handle at the proximal end of the bed for ease in carrying or transporting the prostration bed.

4. The portable bed of claim 2 further comprising a carrying handle at the proximal end of the bed for ease in carrying or transporting the prostration bed.

5. A method of using the prostration bed comprising:
extending the bed lengthwise along a floor or ground surface;
kneeling and stretching across the bed resting the stomach and hips on the solidly cushioned area and placing the face downward into the round opening;
extending each arm forward passing the sides of the head and ears, and resting each arm on the allotted cushioned arm rest;
beginning a focused period of prayer and meditation;
upon completing these contemplative moments, rising from the bed;
either leaving the bed in a specific spot and return to it later, or folding the bed and placing it in a storage component.

6. The bed of claim 1 wherein the bed measures approximately thirty nine inches in width and eighty inches in length.

7. The bed of claim 2 wherein the bed measures approximately thirty nine inches in width and eighty inches in length.
